(19) United States
(12) Patent Application Publication
(10) Pub. No.: US 2018/0062189 A1
(43) Pub. Date: Mar. 1, 2018

(54) COOLANT HEATER

(71) Applicant: Hanon Systems, Daejeon (KR)

(72) Inventors: Hyun Seok JUNG, Daejeon (KR); Kil Sang JANG, Daejeon (KR); Kyung Seok CHO, Daejeon (KR)

(21) Appl. No.: 15/682,797

(22) Filed: Aug. 22, 2017

(30) Foreign Application Priority Data
Aug. 29, 2016 (KR) 10-2016-0109943
Jan. 11, 2017 (KR) 10-2017-0004117

(51) Int. Cl. H01M 8/04223

(52) U.S. Cl. CPC H01M 8/04268; H01M 8/04225

(57) ABSTRACT

Provided is a coolant heater, and more particularly, a coolant heater for improving flow performance of a coolant flowing inside a housing, in which a plurality of heater heating elements are disposed inside the housing to be cooled. More specifically, according to the present invention, to increase a flow velocity of a coolant, a housing has a diameter gradually decreasing toward an outlet of the coolant or a flow guide is formed in a spiral shape along an inner surface of the housing.

### CROSS-REFERENCE TO RELATED APPLICATIONS

This application claims priority under 35 U.S.C. §119 to Korean Patent Application No. 10-2016-0109943 filed on Aug. 29, 2016 and No. 10-2017-0004117 filed on Jan. 11, 2017, in the Korean Intellectual Property Office, the disclosure of which is incorporated herein by reference in its entirety.

### TECHNICAL FIELD

The following disclosure relates to a coolant heater, and more particularly, to a coolant heater for improving flow performance of a coolant flowing inside one housing, in which a plurality of heater heating elements are disposed inside the housing to be cooled.

### BACKGROUND

To develop environmentally friendly vehicles, car makers are great interest in developing fuel cell vehicles.

Generally, a fuel cell vehicle largely includes a fuel cell stack generating electrical energy, a fuel supply device supplying fuel (hydrogen) to the fuel cell stack, an air supply device supplying oxygen in the air which is an oxidizer necessary for an electrochemical reaction of the fuel cell stack, and a thermal management system (TMS) which is a heat and water management system for eliminating heat of reaction of the fuel cell stack to the outside and controlling an operating temperature of the fuel cell stack.

Fuel cell vehicles that are currently being developed involve many problems to be solved. One of the most urgent and difficult problems to be solved may be a strategy for securing cold start performance.

The solution for securing the cold start performance of the existing fuel cell vehicle was quick melting of pure water using the heater inside a rapid thaw accumulator (RTA).

However, there are many difficulties in that if the pure water is used, the pure water is frozen below a freezing point, a coolant loop is also complicated, a separate drain valve has to be installed, or the like.

As one method to solve the problem, there is a method for using antifreeze for a stack as a coolant and quickly heating a coolant to smooth a power generation of a stack at a temperature below a freezing point. For this purpose, a heater is attached to a stack coolant line.

In addition, to prevent durability of the stack from decreasing due to a corrosion of catalyst carrying carbon during start-up/shutdown of the fuel cell vehicle, cathode oxygen depletion (COD) is engaged with both terminals of the stack to consume power generated by a reaction between hydrogen and oxygen as heat, thereby removing residual oxygen in the stack.

Basically, both of the heater for securing the cold start performance and the COD for preventing the durability of the stack from decreasing during the start-up/shutdown are a resistance heater, and are different only in use time and usage but may be integrally formed as one heater.

By the way, since a high-voltage coolant heater of the thermal management system (TMS) of the fuel cell vehicle instantaneously requires high power and has a heat density much higher than that of a general heater, it is important cool the heater for preventing overheating and increasing durability. In such a coolant heater, a heating element may be prevented from locally overheating when the coolant flowing around the heating element flows evenly and is cooled, thereby increasing the durability.

For this purpose, in the existing coolant heater, a guide baffle or a porous hole was installed at an inlet of the coolant in a space where the heater is installed to evenly distribute a flow.

However, the guide baffle requires a certain space to distribute the flow, and therefore there is a limitation in reducing a package size. In addition, a fast flow velocity is also an important factor for cooling, and the baffle alone may not remove a zone where a flow velocity decreases due to local stagnation.

In addition, a porous hole guide is advantageous in even flow distribution but has a disadvantage of decreasing the overall flow velocity.

In order to solve the problem, Korean Patent Laid-Open Publication No. 10-2015-0142433 (published on Dec. 22, 2015, entitled “Conveying fluid distribution apparatus for fuel cell vehicle”) disclosed a fluid flow device including: a housing 4 having a hollow provided therein; at least one cylindrical heater rod 1 installed in the housing; a coolant inflow pipe 3 connected to the housing to introduce a coolant into the housing; a flow distribution structure portion 2 enclosing the heater rods while being spaced apart from the heater rods by a predetermined gap within the housing and fixed to an inner surface of the housing; and a coolant discharge pipe 5 connected to the housing (see FIG. 1).

In the above patent, the baffle is removed at a position into which the coolant is introduced, and the flow distribution structure portion 1 using a predetermined gap is formed to increase a flow velocity of a coolant passing through a heater.

However, the above patent discloses a flow distribution device having a partition wall structure in which upper and lower ends of a heating element are separately cooled, which still causes difficulty in resolving a stagnation zone of the flow and thus locally overheating.

### RELATED ART DOCUMENT

### Patent Document

Korean Patent Laid-Open Publication No. 10-2015-0142433 (published on Dec. 22, 2015, entitled: “Conveying fluid distribution apparatus for fuel cell vehicle”)

### SUMMARY

An embodiment of the present invention is directed to providing a coolant heater capable of improving flow performance of a coolant flowing in a housing by including a plurality of heater heating elements disposed in the housing so that the heater heating elements are cooled, with the heater heating elements having a diameter gradually decreasing toward a coolant outlet, or including a flow guide formed in a spiral shape along an inner surface of the housing.

In one general aspect, a coolant heater includes: a housing 100 having a hollow provided therein, including an inlet 101 into which a coolant is introduced and an outlet 102 through which the coolant is discharged, and having a cross sectional area decreasing toward the outlet 102; and a plurality of heater heating elements 200 disposed inside the housing 100 to be supplied with high voltage power.

The housing 100 may have the inlet 101 formed at the lower end part thereof and the outlet 102 formed at the upper end part thereof in a height direction.

The housing 100 may have a cylindrical shape in which the housing 100 has a diameter gradually decreasing toward an upper end part thereof in the height direction.

The inlet 101 and the outlet 102 may be provided with the inlet pipe 110 and the outlet pipe 120 which are disposed in parallel with a tangential direction of the housing 100.

In another general aspect, a coolant heater includes: a housing 100 having a hollow provided therein and including an inlet 101 into which a coolant is introduced and an outlet 102 through which the coolant is discharged; a plurality of heater heating elements 200 disposed inside the housing 100 to be supplied with high voltage power; and a flow guide 300 formed in a spiral shape along an inner surface of the housing 100.

The housing 100 may have a cylindrical shape.

The housing 100 may have the inlet 101 formed at the lower end part thereof and the outlet 102 formed at the upper end part thereof in a height direction.

The housing 100 may have a shape in which the housing 100 has a diameter gradually decreasing toward an upper end part thereof in the height direction.

The inlet 101 and the outlet 102 may be provided with the inlet pipe 110 and the outlet pipe 120 which are disposed in parallel with a tangential direction of the housing 100.

The housing 100 may be configured so that a direction in which the coolant introduced through the inlet 101 rotates and flows along an inner surface thereof and a direction in which the flow guide 300 extends in a spiral shape are the same.

The flow guide 300 may extend while rotating at least once.

The flow guide 300 may protrude inwardly of the housing 100 and may be spaced apart from the heater heating element 200 by a predetermined distance.

The coolant heater 10 may further include a flow velocity increasing portion 400 which extends in a height direction in a space between the plurality of heater heating elements 200 within the housing 100.

The flow velocity increasing portion 400 may be disposed in an empty space in the middle between the plurality of heater heating elements 200.

At least one of the flow velocity increasing portions 400 may be disposed between the plurality of heater heating elements 200.

Other features and aspects will be apparent from the following detailed description, the drawings, and the claims.

### BRIEF DESCRIPTION OF THE DRAWINGS

FIG. 1 is a transverse cross-sectional view of the existing fluid flow device for fuel cell vehicles.

FIGS. 2 to 4 are perspective views and a longitudinal cross-sectional view of a coolant heater according to an exemplary embodiment of the present invention.

FIG. 5 is a longitudinal cross-sectional view illustrating an example in which a flow velocity increasing portion is formed inside the housing of FIG. 2.

FIGS. 6 and 7 are perspective views illustrating a coolant heater according to another exemplary embodiment of the present invention.

FIG. 8 is a perspective view illustrating a flow guide of the coolant heater according to the exemplary embodiment of the present invention.

FIG. 9 is a longitudinal cross-sectional view illustrating an inside of the housing of FIG. 6.

FIGS. 10 and 11 are a perspective view and a plan view of a coolant heater according to various exemplary embodiments of the present invention viewed from the top.

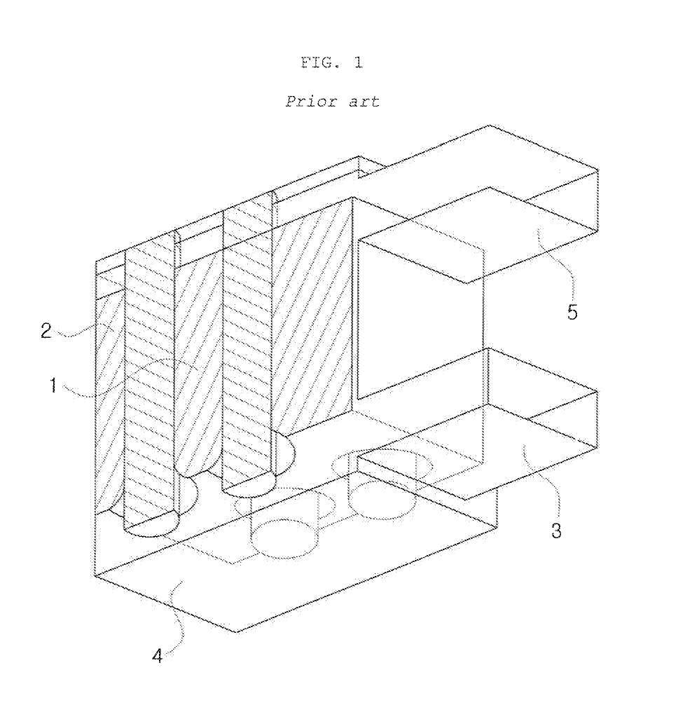

[Detailed Description of Main Elements]

| | |
|---|---|
| 10: Coolant heater | |
| 100: Housing | |
| 101: Inlet | 102: Outlet |
| 110: Inlet pipe | 120: Outlet pipe |
| 200: Heater heating element | |
| 300: Flow guide | |
| 400: Flow velocity increasing portion | |

### DETAILED DESCRIPTION OF EMBODIMENTS

Hereinafter, a coolant heater 10 according to an exemplary embodiment of the present invention as described above will be described in detail with reference to the accompanying drawings.

The present invention relates to a coolant heater capable of improving flow performance of a coolant flowing in a housing by disposing a plurality of heater heating elements in one housing so that the heater heating elements are cooled, having a diameter of the housing gradually decreasing toward a coolant outlet, or including a flow guide formed in a spiral shape along an inner surface of the housing.

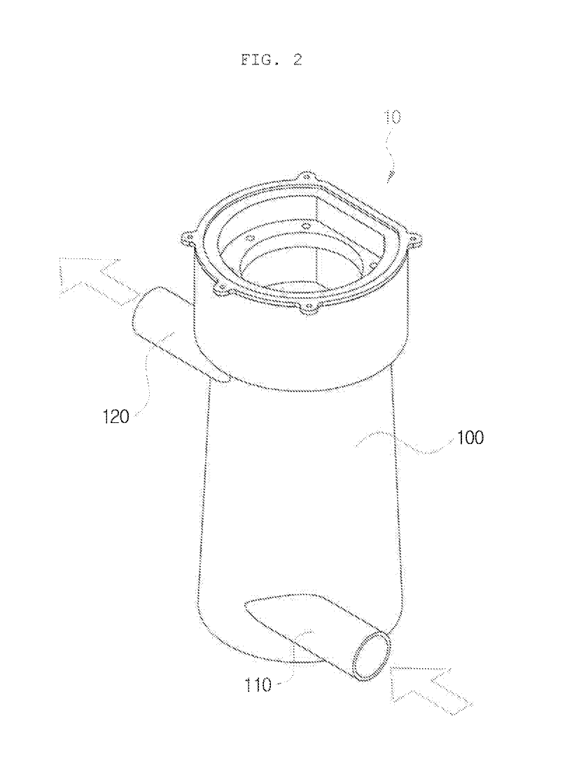

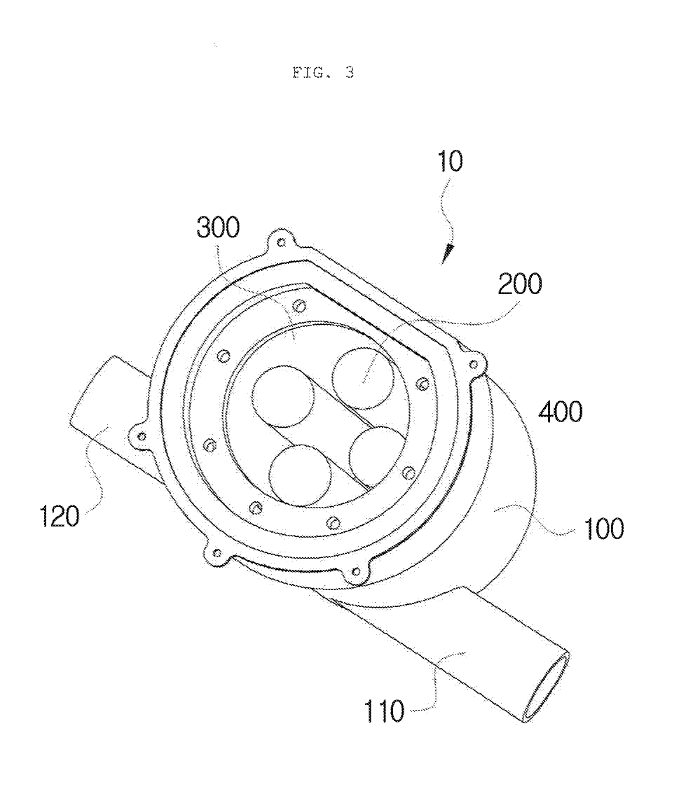

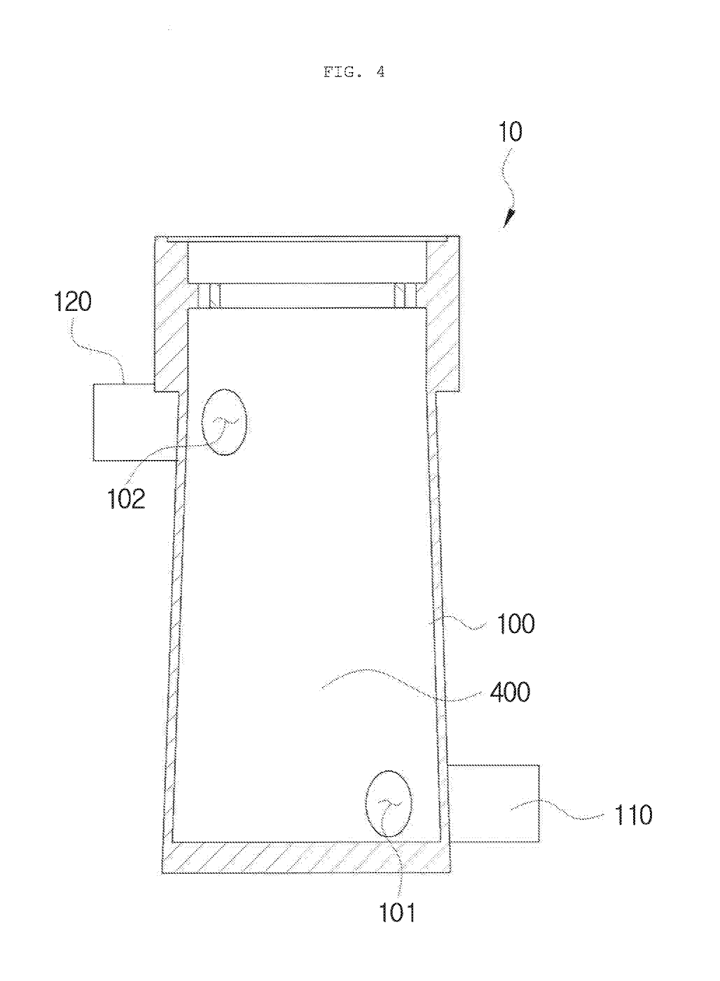

First, exemplary embodiments illustrated in FIGS. 2 to 4 will be described be below.

A coolant heater illustrated in FIGS. 2 to 4 according to an exemplary embodiment includes a housing having a diameter gradually decreasing toward an outlet and a heater heating element.

The coolant heater 10 does not have a structure in which a plurality of heater heating elements 200 are separately cooled but has a structure in which the plurality of heater heating elements 200 are cooled in an integrated housing.

First, the housing 100 has a hollow provided therein, and includes an inlet 101 through which a coolant is introduced and an outlet 102 through which the coolant is discharged.

At this time, the housing 100 is formed to have a gradually decreasing cross-sectional area toward the outlet 102, such that the flow velocity of the coolant introduced into the housing 100 through the inlet 101 may be prevented from decreasing due to a resistance while the coolant flows toward the outlet 102.

The housing 100 is preferably formed so that a cross sectional area of a side where the outlet 102 is positioned decreases to 85% or less with respect to that of a side where the inlet 101 is positioned, thereby making the effect of preventing the flow velocity from decreasing a certain level or more.

Particularly, since a lower end part and an upper end part of the housing 100 are each provided with the inlet 101 and the outlet 102 in a height direction, the flow velocity is likely to slow down while the coolant goes upward. According to the present invention, the cross sectional area of the housing decreases toward the top, thereby improving the flow performance of the coolant.

As illustrated in FIGS. 2 to 4, the housing 100 may have a cylindrical shape, which is not necessarily limited to a cylindrical shape. Accordingly, the housing may be changed to any other shape.

In addition, the inlet 101 and the outlet 102 may be provided with an inlet pipe 110 and an outlet pipe 120 which are disposed in parallel with a tangential direction of the housing 100.

Particularly, in the coolant heater 10, as the inlet pipe 110 is positioned at a lower end part of the housing 100 and an inner channel of the inlet pipe 110 is formed in the tangential direction of an inner surface of the housing 100, the coolant introduced into the housing 100 through the inlet pipe 110 at the lower end part of the housing can flow while rotating in a circumferential direction along the inner surface of the housing 100.

Next, the coolant heater 10 further includes a plurality of heater heating elements 200 which are disposed inside the housing 100.

The heater heating element 200 may be supplied with high voltage power and may be a CNT heating element, a heating element using a PTC element, or a cartridge heater.

At this time, the plurality of heater heating elements 200 may have the same characteristics or may have different characteristics. Here, the characteristics mentioned herein may mean heating capacity or a type of heating elements.

The heater heating element 200 is connected to a power supply means of a fuel cell vehicle, and is supplied with high voltage power by the connection.

Here, the power supply means of the vehicle may be only a battery in the case of an internal combustion engine vehicle or may be a battery or a fuel cell stack in the case of a fuel cell vehicle or a hybrid vehicle, or the like. Accordingly, the power supply means is collectively referred to as means provided in the vehicle capable of supplying power.

At this time, the heater heating element 200 may extend long in the height direction of the housing 100, and may be disposed to be perpendicular to the inlet pipe 110 and the outlet pipe 120.

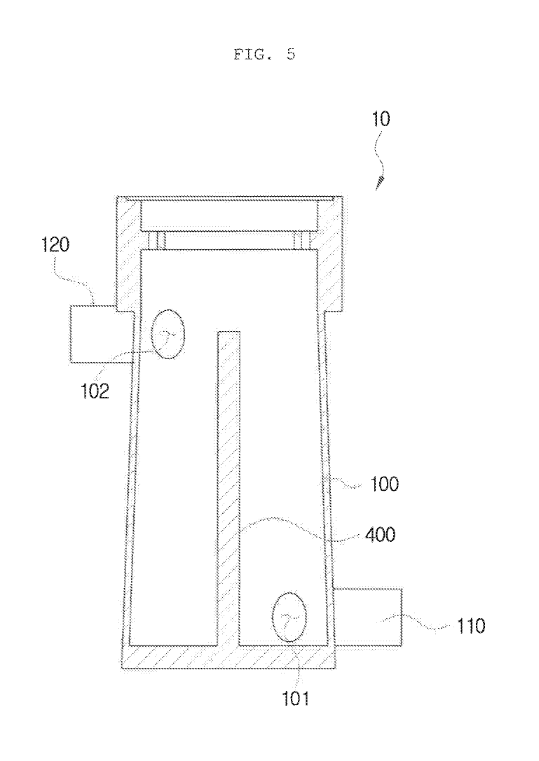

In addition, as illustrated in FIG. 5, the coolant heater 10 may further include a flow velocity increasing portion 400 which extends in a height direction in a space between the plurality of heater heating elements 200 within the housing 100.

The flow velocity increasing portion 400 is to increase the flow velocity in a zone where the coolant may stagnate between the heater heating elements 200 or the flow velocity may slow down.

As illustrated in FIG. 5, the flow velocity increasing portion is formed in an empty space in the middle of the space between the heater heating elements 200 and thus is surrounded by the heater heating elements 200, thereby making a flow velocity a certain velocity or more in a zone where the flow velocity may suddenly decrease.

In addition, the flow velocity increasing portion 400 may be a pipe having a rectangular cross section or a pipe having a cylindrical cross section, and may have a spiral shape to minimize the resistance of the coolant.

Accordingly, the coolant heater 10 may make the flow of the coolant even by the flow guide 300 formed along an inner circumferential surface of the housing 100, thereby preventing the heater heating element 200 from locally overheating and efficiently cooling the heater heating element 200.

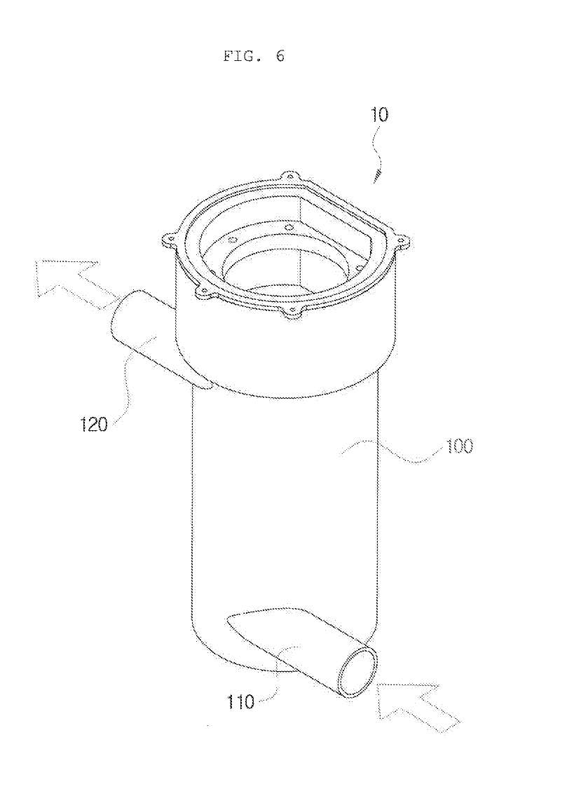

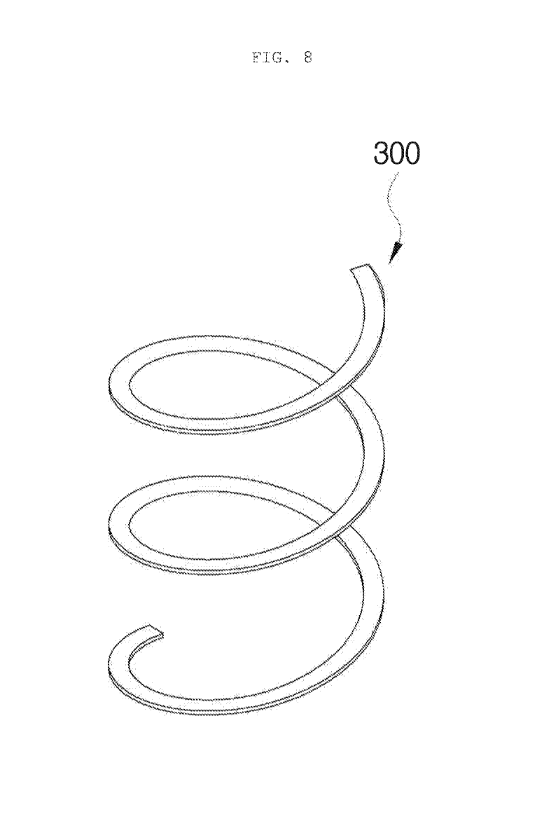

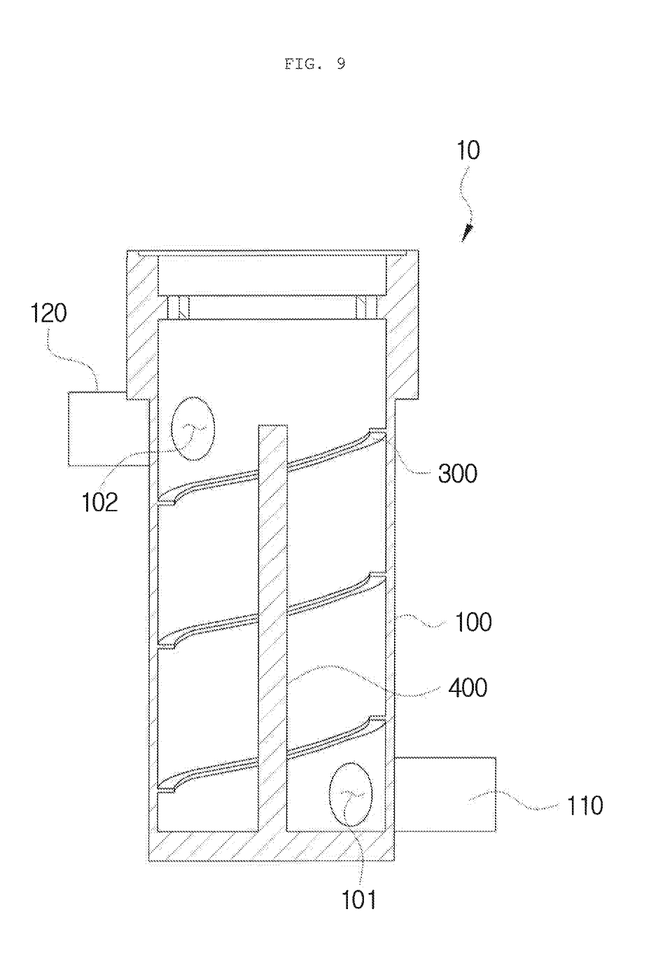

Next, exemplary embodiments illustrated in FIGS. 6 to 11 will be described below.

The coolant heater includes a flow guide formed in a spiral shape along the inner surface of the housing and is configured to largely include the housing 100, the heater heating element 200, and the flow guide 300.

First, the housing 100 has a hollow provided therein, and includes the inlet 101 through which a coolant is introduced and the outlet 102 through which the coolant is discharged.

As illustrated in FIG. 6, the housing 100 may have a cylindrical shape, which is not necessarily limited to a cylindrical shape. Accordingly, the housing may be changed to any other shape.

However, the housing 100 illustrated in FIGS. 6 to 11 has a cylindrical shape so that the coolant introduced through the inlet 101 flows while rotating along the flow guide 300 formed on the inner surface of the housing 100. Accordingly, the housing preferably has a cylindrical shape to improve the fluidity.

In addition, the housing 100 may have the inlet 101 formed at the lower end part thereof and the outlet 102 formed at the upper end part thereof in the height direction.

Accordingly, the coolant heater 10 may be configured to smoothly discharge bubbles generated due to the flow of the coolant and drifting on an upper surface of the coolant through the outlet 102 formed at the upper side thereof. At this time, it is preferable that the outlet 102 is disposed to be as close as possible to an upper wall.

In addition, as illustrated in FIGS. 2 to 4, the housing 100 may have a diameter gradually decreasing toward the upper end part in the height direction, that is, toward the outlet 102, in order to increase the flow velocity of the coolant flowing therein.

Meanwhile, the inlet 101 and the outlet 102 may be provided with the inlet pipe 110 and the outlet pipe 120 which are disposed in parallel with the tangential direction of the housing 100.

In the coolant heater 1, as the inlet pipe 110 is positioned at a lower end part of the housing 100 and an inner channel of the inlet pipe 110 is formed in the tangential direction of an inner surface of the housing 100, the coolant introduced into the housing 100 through the inlet pipe 110 at the lower end part of the housing can flow while rotating in a circumferential direction along the inner surface of the housing 100.

The heater heating element 200 is the same as that of FIGS. 2 to 4, and the description thereof will be omitted.

Next, the flow guide 300 is formed in a spiral shape along the inner surface of the housing 100 to serve to guide the flow direction of the coolant introduced into the housing 100.

The flow guide 300 may be integrally formed with the housing 100 or may be formed as a separate structure to be coupled to the inside of the housing 100.

Accordingly, the coolant heater 10 is provided with the spiral flow guide 300 having a spring shape along the inner surface of the housing 100, such that when the coolant rotates in a circumferential direction within the housing 100, the coolant may be prevented from excessively spreading in a vertical direction.

At this time, the housing 100 is formed so that the direction in which the coolant introduced through the inlet 101 rotates and flows along the inner surface thereof and the direction in which the flow guide 300 extends in a spiral shape are the same.

In addition, the flow guide 300 is preferably formed to rotate at least once and extend in a spiral shape so that the coolant may move upward while rotating within the housing 100.

As described above, the flow guide 300 and the plurality of heater heating elements 200 are disposed in the housing 100. Here, the flow guide 300 is preferably spaced apart from the heater heating element 200 by a predetermined distance, thereby securing the moving space of the coolant and preventing the flow guide 300 from being deformed due to the high-temperature heater heating element 200.

Meanwhile, the coolant heater 10 may further include the flow velocity increasing portion 400 which extends in a height direction in a space between the plurality of heater heating elements 200, within the housing 100.

The flow velocity increasing portion 400 is to increase the flow velocity in a zone where the coolant may stagnate between the heater heating elements 200 or the velocity may slow down and may have to extend long in the height direction by the height corresponding to the heater heating element 200.

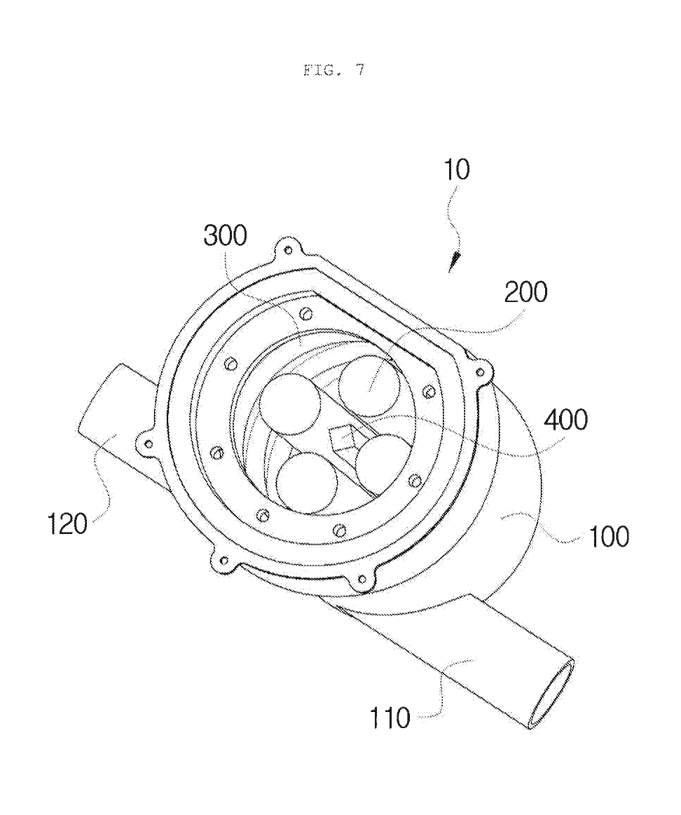

As illustrated in FIGS. 7 to 11, the flow velocity increasing portion is formed in an empty space in the middle of the space between the heater heating elements 200 and thus is surrounded by the heater heating element 200, thereby making a flow velocity a certain velocity or more in a zone where the flow velocity may suddenly decrease.

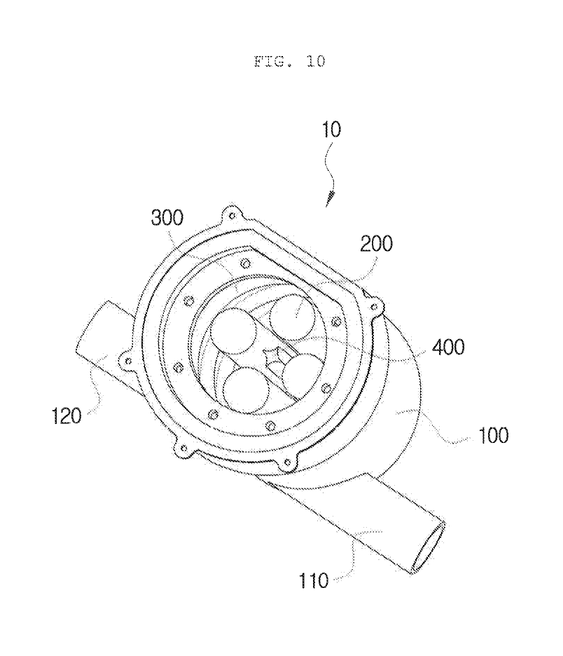

As illustrated in FIG. 7, the flow velocity increasing portion may be a pipe having a rectangular cross section or a pipe having a cylindrical cross section, or may be formed in a spiral shape as illustrated in FIG. 10 to minimize the resistance of the coolant.

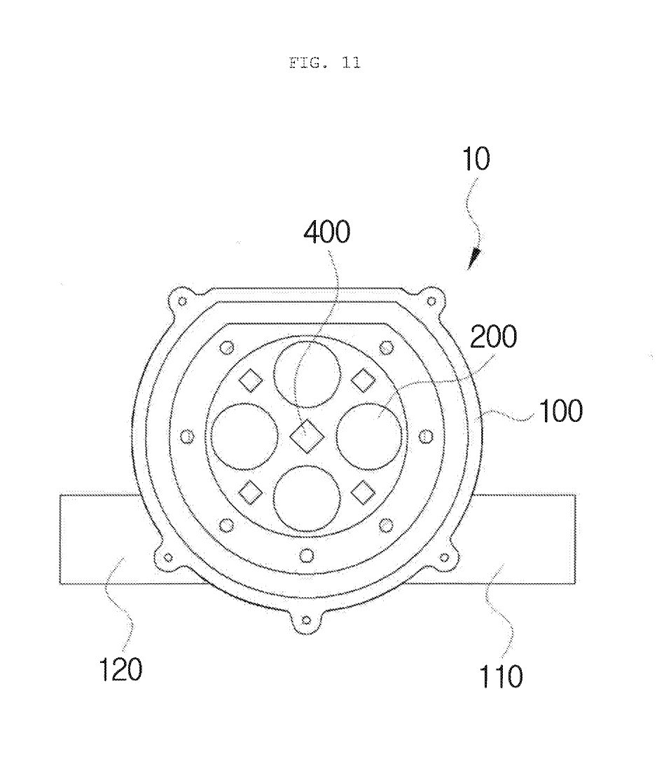

In addition, only one flow velocity increasing portion may be disposed in an empty space in the middle of the space between the heater heating elements 200 as illustrated in FIGS. 7 and 10 and a plurality of flow velocity increasing portions may be disposed between the plurality of heater heating elements 200 at an appropriate distance as illustrated in FIG. 11.

Accordingly, the coolant heater 10 may make the flow of the coolant even by the flow guide 300 formed along an inner circumferential surface of the housing 100, thereby preventing the heater heating element 200 from locally overheating and efficiently cooling the heater heating element 200.

In addition, in the coolant heater 100, the flow velocity increasing portion 400 is disposed in the empty space around the heater heating element 200, thereby increasing the flow velocity in the zone where the coolant may stagnate between the heating elements or the flow velocity may slow down.

As a result, the coolant heater 10 according to the exemplary embodiment of the present invention can improve the flow performance to improve the cooling performance and the durability of the heater heating element 200 and increase the space utilization in the vehicle due to the compact structure.

According to the coolant heater in accordance with the exemplary embodiment of the present invention, the plurality of heater heating elements are disposed in one housing to be cooled and the spiral flow guide is provided in the cylindrical coolant housing, thereby improving the flow performance of the coolant flowing in the housing.

More specifically, the coolant heater in accordance with the exemplary embodiment of the present invention does not have the structure in which the plurality of heater heating elements are separately cooled but has the structure in which the plurality of heater heating elements are cooled in the integrated housing, thereby saving the space.

In addition, the coolant heater in accordance with the exemplary embodiment of the present invention does not require the separate flow distribution zone or the installation space of the structure such as the partition wall, such that it may be implemented in the compact package.

In addition, the coolant heater in accordance with the exemplary embodiment of the present invention can make the flow of the coolant even by the flow guide formed along the inner circumferential surface of the housing, thereby preventing the heater heating element from locally overheating and effectively cooling the heater heating element.

In addition, according to the coolant heater in accordance with the exemplary embodiment of the present invention, the flow velocity increasing portion is disposed in the empty space around the heater heating element, thereby increasing the flow velocity in the zone where the coolant may stagnate between the heating elements or the flow velocity may slow down.

In addition, according to the coolant heater in accordance with the exemplary embodiment of the present invention, the diameter of the housing may be formed to gradually decrease toward the coolant outlet, thereby minimizing the decrease in the flow velocity due to the resistance while the coolant rises toward the outlet formed at the upper end part of the housing.

Accordingly, according to the coolant heater in accordance with the exemplary embodiment of the present invention, the cooling performance of the heater heating element may be improved to resolve the local overheating and decrease the whole surface temperature, thereby increasing the durability of the heater.

As a result, the coolant heater in accordance with the exemplary embodiment of the present invention can improve the flow performance to improve the cooling performance and the durability of the heater heating element and increase the space utilization in the vehicle due to the compact structure.

The present invention is not limited to the above-mentioned exemplary embodiments but may be variously applied, and may be variously modified by those skilled in the art to which the present invention pertains without departing from the gist of the present invention claimed in the claims.

What is claimed is:

1. A coolant heater, comprising:
a housing having a hollow provided therein, including an inlet through which a coolant is introduced and an outlet through which the coolant is discharged, and having a cross sectional area decreasing toward the outlet; and
a plurality of heater heating elements disposed inside the housing to be supplied with high voltage power.

2. The coolant heater of claim 1, wherein the housing has the inlet formed at a lower end part thereof and the outlet formed at an upper end part thereof in a height direction.

3. The coolant heater of claim 2, wherein the housing has a cylindrical shape in which the housing has a diameter gradually decreasing toward the upper end part thereof in the height direction.

4. The coolant heater of claim 3, wherein the inlet and the outlet are provided with an inlet pipe and an outlet pipe which are disposed in parallel with a tangential direction of the housing.

5. The coolant heater of claim 4, wherein the inlet pipe and the outlet pipe are disposed to be perpendicular to the heater heating element.

6. The coolant heater of claim 1, further comprising:
a flow velocity increasing portion which extends in a height direction in a space between the plurality of heater heating elements within the housing.

7. The coolant heater of claim 6, wherein the flow velocity increasing portion is disposed in an empty space in the middle between the plurality of heater heating elements.

8. A coolant heater, comprising:
a housing having a hollow provided therein and including an inlet through which a coolant is introduced and an outlet through which the coolant is discharged;
a plurality of heater heating elements disposed inside the housing to be supplied with high voltage power; and
a flow guide formed in a spiral shape along an inner surface of the housing.

9. The coolant heater of claim 8, wherein the housing has a cylindrical shape.

10. The coolant heater of claim 8, wherein the housing has the inlet formed at a lower end part thereof and the outlet formed at an upper end part thereof in a height direction.

11. The coolant heater of claim 10, wherein the housing has a shape in which the housing has a diameter gradually decreasing toward the upper end part thereof in the height direction.

12. The coolant heater of claim 11, wherein the inlet and the outlet are provided with an inlet pipe and an outlet pipe which are disposed in parallel with a tangential direction of the housing.

13. The coolant heater of claim 12, wherein the inlet pipe and the outlet pipe are disposed to be perpendicular to the heater heating element.

14. The coolant heater of claim 13, wherein the housing is configured so that a direction in which the coolant introduced through the inlet rotates and flows along an inner surface thereof and a direction in which the flow guide extends in a spiral shape are the same.

15. The coolant heater of claim 8, wherein the flow guide extends while rotating at least once.

16. The coolant heater of claim 8, wherein the flow guide protrudes inwardly of the housing and is spaced apart from the heater heating element by a predetermined distance.

17. The coolant heater of claim 8, further comprising:
a flow velocity increasing portion which extends in a height direction in a space between the plurality of heater heating elements within the housing.

18. The coolant heater of claim 17, wherein the flow velocity increasing portion is disposed in an empty space in the middle between the plurality of heater heating elements.

19. The coolant heater of claim 17, wherein at least one of the flow velocity increasing portions is disposed between the plurality of heater heating elements.
